(19) United States
(12) Patent Application Publication
(10) Pub. No.: US 2002/0113404 A1
(43) Pub. Date: Aug. 22, 2002

(54) Auxiliary structure for stabilizing a rock-and-roll play cart

(75) Inventor: Ming Chang Yang, Chang-Hua Hsien (TW)

Correspondence Address: Harrison and Egbert, 412 Main Street, 7th Floor, Houston, TX, 77002, US

(73) Assignee: Chia Da Bicycle Co., Ltd.

(21) Appl. No.: 09/788,251

(22) Filed: Feb. 20, 2001

(51) Int. Cl. B62H 1/00

(52) U.S. Cl. 280/293

(57) ABSTRACT

A rock-and-roll play cart wherein an auxiliary wheel is provided in a front wheel frame so as to prevent the overturn of the play cart at such time when the play cart is tilted.

### FIELD OF THE INVENTION

The present invention relates generally to a play cart, and more particularly to an auxiliary structure for preventing the overturn of the play cart.

### BACKGROUND OF THE INVENTION

As shown in FIG. 1, a rock-and-roll play cart of the prior art comprises an upright steering rod 13, two rear wheels 12, and a front wheel 16. As the prior art play cart is moved forward, the front wheel 16 swivels leftward and rightward. When the upright steering rod 13 is tilted, as indicated by an arrow, the front wheel 16 swivels aside, thereby upsetting the center of gravity of the play cart. As a result, the play cart is apt to overturn, especially at the time when the play cart is engaged in a rock-and-roll movement.

### SUMMARY OF THE INVENTION

The primary objective of the present invention is to provide a rock-and-roll play cart which is free of the drawback of the prior art rock-and-roll play cart described above.

In keeping with the principle of the present invention, the foregoing objective of the present invention is attained by a rock-and-roll play cart comprising a body frame, two rear wheels, an upright steering rod, a front wheel frame, and two front wheels pivoted to the rear end of the front wheel frame. The play cart of the present invention is characterized by the front wheel frame which is provided with an auxiliary wheel pivoted thereto. The auxiliary wheel is not in contact with the ground surface when the play cart is moved forward. As the play cart is tilted, the auxiliary wheel comes in contact with the ground surface so as to provide the play cart with an auxiliary support point to prevent the overturn of the play cart.

The foregoing objective and features of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a rock-and-roll play cart of the prior art in action.

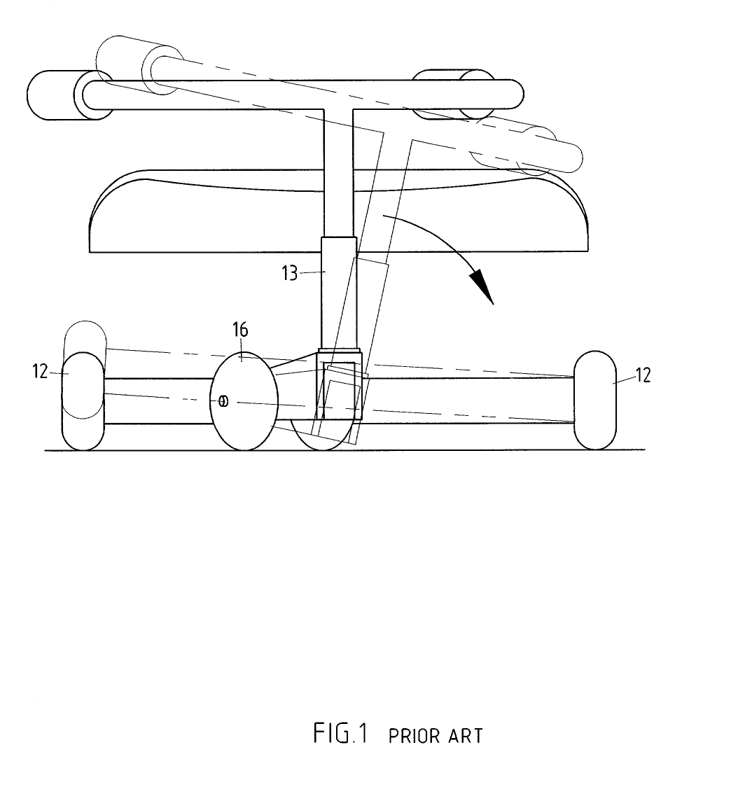

FIG. 2 shows a perspective view of a rock-and-roll play cart of the preferred embodiment of the present invention.

FIG. 3 shows an exploded view of an auxiliary structure of the play cart of the preferred embodiment of the present invention.

FIG. 4 shows a side schematic view of the play cart of the preferred embodiment of the present invention in combination.

FIG. 5 shows a top view of the play cart of the preferred embodiment of the present invention in action.

FIG. 6 shows a front view of the play cart of the preferred embodiment of the present invention in action.

### DETAILED DESCRIPTION OF THE PREFERRED EMBODIMENT

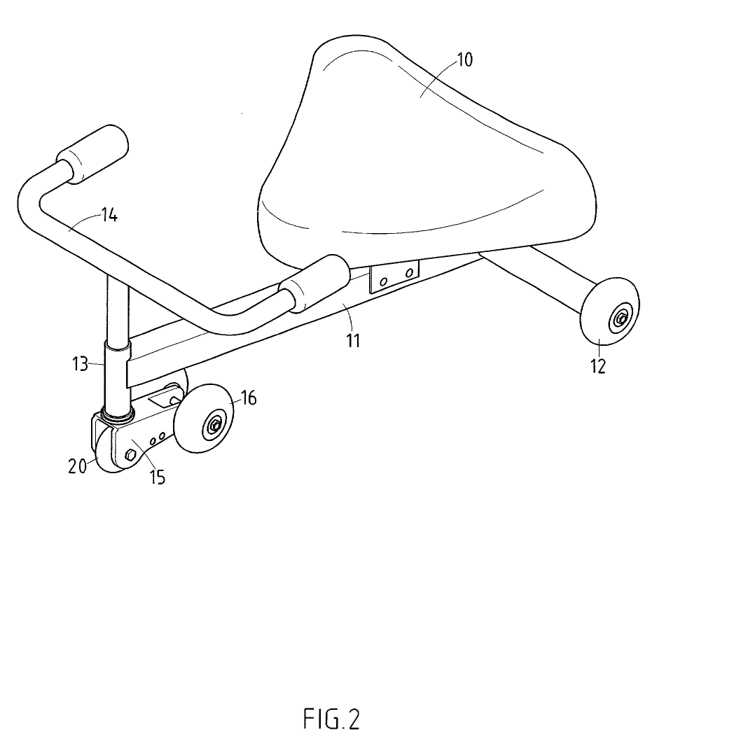

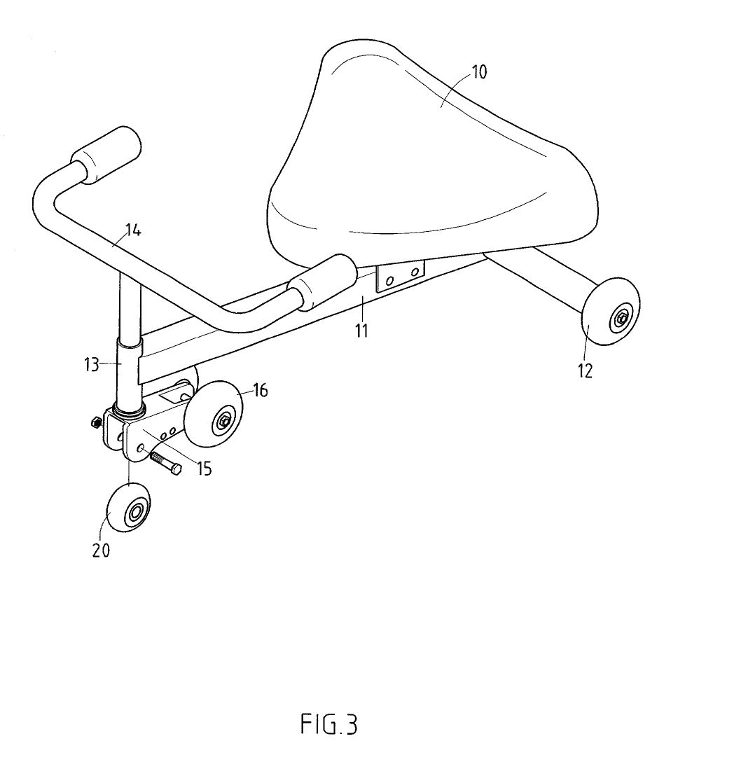

As shown in FIGS. 2-4, a rock-and-roll play cart embodied in the present invention comprises a seat 10, a body frame 11 on which the seat 10 is mounted, two rear wheels 12 pivoted to two opposite ends of the rear end of the body frame 11, an upright steering rod 13 fastened with the front end of the body frame 11, a handlebar 14 supported by the top end of the upright steering rod 13, a front wheel frame 15 fastened with the bottom end of the upright steering rod 13, and two front wheels 16 pivoted to two opposite ends of the rear end of the front wheel frame 15.

The rock-and-roll play cart of the preferred embodiment of the present invention is characterized by the front wheel frame 15 which is provided with an auxiliary wheel 20 pivoted thereto. The auxiliary wheel 20 is fastened pivotally to the front end of the front wheel frame 15 such that the auxiliary wheel 20 is not in contact with a surface on which the play cart of the present invention is rested by means of the two rear wheels 12 and the two front wheels 16. In other words, only the rear wheels 12 and the front wheels 16 are in contact with the surface.

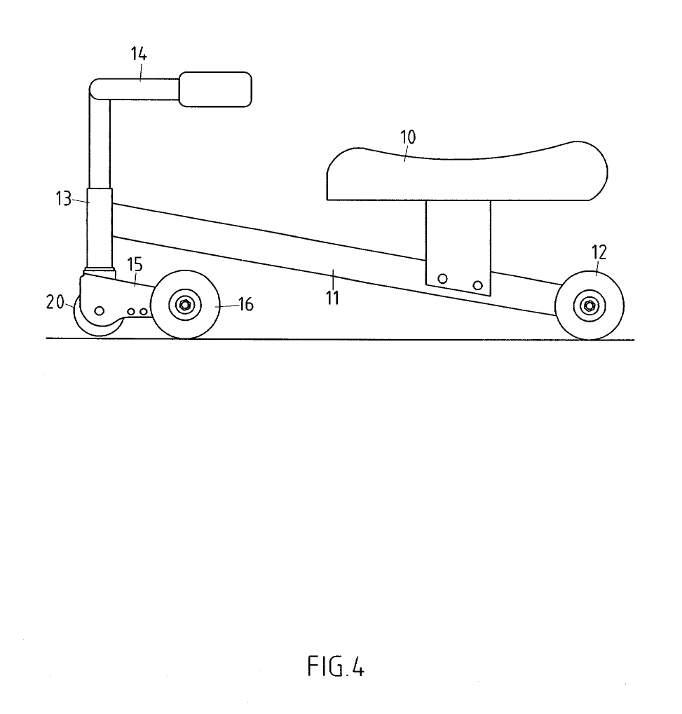

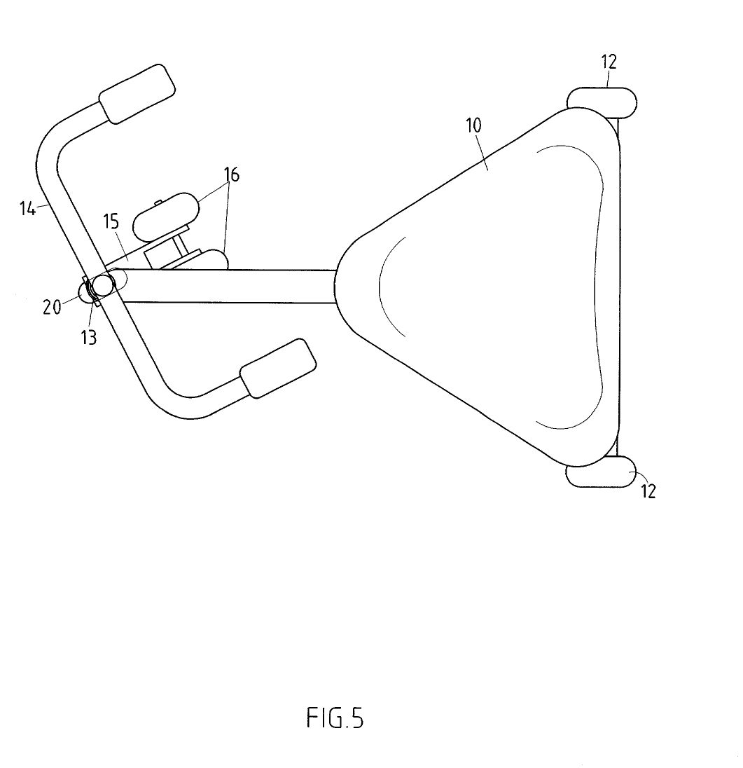

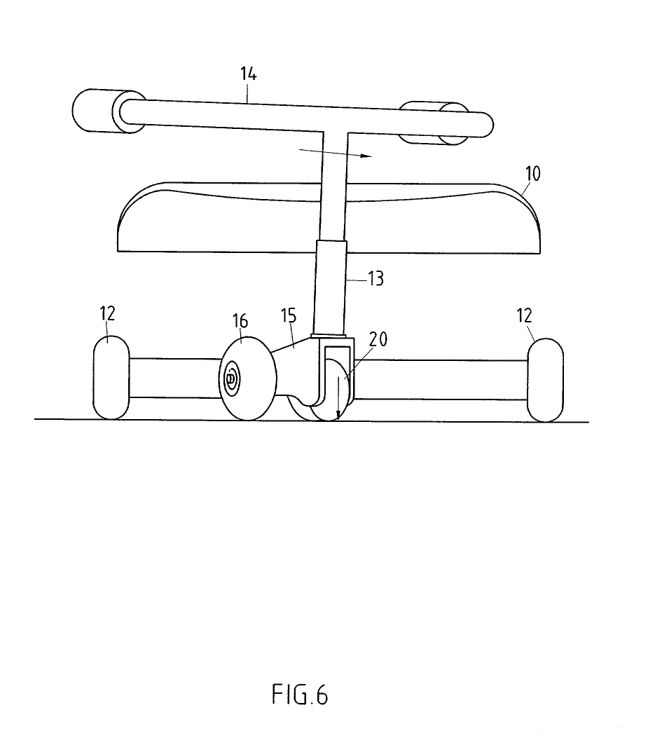

As the play cart is moved forward, the auxiliary wheel 20 does not come in contact with the surface on which the play cart is moved, as shown in FIG. 4. When the play cart of the present invention is tilted, the auxiliary wheel 20 comes in contact with the surface, thereby resulting in an auxiliary support to the tilted play cart, as illustrated in FIGS. 5 and 6. The auxiliary wheel 20 plays the role of preventing the overturn of the play cart of the present invention, especially at the time when the play cart of the present invention is engaged in a rock-and-roll movement.

The embodiment of the present invention described above is to be regarded in all respects as being merely illustrative, and not restrictive. Accordingly, the present invention may be embodied in other specific forms without deviating from the spirit thereof . The present invention is therefore to be limited only by the scope of the following appended claim.

What is claimed is:

1. A rock-and-roll play cart comprising:
a body frame;
a seat mounted on a rear end of said body frame;
two rear wheels pivoted to two opposite ends of the rear end of said body frame;
an upright steering rod fastened with a front end of said body frame;
a handlebar supported by a top end of said upright steering rod;
a front wheel frame fastened with a bottom end of said upright steering rod; and
two front wheels pivoted to two opposite ends of a rear end of said front wheel frame;
wherein said front wheel frame is provided with an auxiliary wheel pivoted to a front end of said front wheel frame such that said auxiliary wheel is not in contact with a surface on which said two front wheels and said two rear wheels are rested whereby said auxiliary wheel comes in contact with the surface at the time when said rock-and-roll play cart is tilted.
